(19) United States
(12) Patent Application Publication
(10) Pub. No.: US 2022/0042552 A1
(43) Pub. Date: Feb. 10, 2022

(54) OVERLOAD CLUTCH

(71) Applicant: Centa-Antriebe Kirschey GmbH, Haan (DE)

(72) Inventor: Monday UGBEKILE, Haan (DE)

(21) Appl. No.: 17/382,529

(22) Filed: Jul. 22, 2021

(30) Foreign Application Priority Data
Aug. 4, 2020 (EP) 20189330.2

(51) Int. Cl. F16D 7/02

(52) U.S. Cl. CPC F16D 7/025

(57) ABSTRACT

An overload clutch, for example a slip clutch, for the transmission of a torque limited in its strength, acting about a torque axis, from a driving part, for example a transmission of a drive shaft of a wind turbine, to an driven part situated, in particular, axially downstream, for example a drive train of a generator, having: at least one first body connected to either the driving part or the driven part in a torque-resistant manner, and at least one second body correspondingly connected to the other part in a torque-resistant manner, i.e. the driven part or the driving part, respectively, wherein the second body has a plurality of frictional elements biased against frictional counterparts on the first body along at least one biasing axis while forming a frictional engagement between the first body and the second body, wherein the frictional elements are supported in frictional element seats within the second body to be moveable, in particular displaceable, along the biasing axis.

The present invention relates to an overload clutch, for example a slip clutch, for the transmission of a torque M limited in its strength, acting about a torque axis A_{M}, from a driving part, for example a transmission of a drive shaft of a wind turbine, to a driven part situated, in particular, axially downstream, for example a drive train of a generator, comprising: at least one first body connected to either the driving part or the driven part in a torque-resistant manner, and at least one second body correspondingly connected to the other part in a torque-resistant manner, i.e. the driven part or the driving part, respectively, wherein the second body comprises a plurality of frictional elements biased against frictional counterparts on the first body along at least one biasing axis A_{V} while establishing a frictional engagement between the first body and the second body, wherein the frictional elements are supported in frictional element seats within the second body to be moveable, in particular displaceable, along the biasing axis A_{V}.

Such clutches are known from the state of the art. They are mostly formed as slip clutches and protect against overload, for example, protect a transmission against load peaks, which can be induced by the generator of a wind turbine, among other things. Undesirable torque increases can result, in particular, due to feedback from the electricity utility. In such a case the overload clutch will react, wherein the overload portion of the torque peak is dissipated by friction linings of the slip clutch or of the overload clutch sliding against each other. A certain residual torque continues to be transmitted. Therefore, the slide clutches discussed here are, among other things, load-maintaining but overload discarding clutches. Due to the above-mentioned design, it is possible, for example, to protect the transmission of a wind turbine against being overloaded.

Such overload clutches can be problematic, however, because of their often very complex design, in particular in regard of the high loads to be dissipated. Since the dissipation of overload peaks only occurs rarely, there is a need to form such an overload clutch for the highest cost-effectiveness and the best ease of assembly.

This object, is achieved by an overload clutch according to the independent claim.

In particular, the object is achieved by an overload clutch, for example a slip clutch, for the transmission of a torque M limited in its strength, acting about a torque axis A_{M}, from a driving part, for example a transmission of a drive shaft of a wind turbine, to a driven part situated, in particular, axially downstream, for example a drive train of a generator, comprising: at least one first body connected to either the driving part or the driven part in a torque-resistant manner, and at least one second body correspondingly connected to the other part in a torque-resistant manner, i.e. the driven part or the driving part, respectively, wherein the second body comprises a plurality of frictional elements biased against frictional counterparts on the first body along at least one biasing axis A_{V} while forming a frictional engagement between the first body and the second body, wherein the frictional elements are supported in frictional element seats within the second body to be moveable, in particular displaceable, along the biasing axis A_{V}, and wherein the frictional elements are supported in frictional element seats within the second body to be moveable, in particular displaceable, along the biasing axis A_{V}.

One point of the invention is the formation of an overload clutch comprising frictional elements supported to be axially moveable and, in particular, displaceable while establishing a frictional engagement with complementary frictional counterparts in each of the bodies to be connected, or driving or driven parts, so that the required torque is transmissible from the driving part, to the driven part. Load peaks are reliably dissipated by the definition of a maximally transmissible frictional force, wherein the set torque remains to be transmissible. The torques to be transmitted are directly dependent, among other things, on the applied biasing force between the frictional elements and the frictional counterparts.

What is relevant is that due to the axially displaceable design of the frictional elements, optionally no bias acts from the first to the second body in which the frictional elements are supported. Due to the displaceability of the frictional elements relative to the second body, it is conceivable that the second body remains displaceable, in particular, axially displaceable with respect to the first body, wherein axial tolerances, among other things, remain able to be compensated. Moreover, axial discontinuities in the force transmission operation are compensated.

According to the present invention, the frictional force is transmitted, i.e., between the frictional elements supported in the second body to be axially displaceable and the frictional counterparts in particular fixedly supported or formed on the first body. In the scope of the present invention, the wording “or vice-versa” means that the components mentioned could also be formed on the other body of the assembly mentioned in the respective context. For example, the frictional elements could also be formed on the first body while the frictional counterparts could be formed on the second body.

Frictional counterparts can be any type of element able to establish, under bias, a frictional engagement with the frictional elements. Optionally, the frictional counterparts, in such an overload clutch, are coatings, surfaces integrally formed with the respective body, bodies or similar areas, separately formed elements and, in particular, inlays. It is conceivable, for example, to form a frictional counterpart as part of the surface of the first or second body, without explicitly coating or treating it and/or subjecting it to processing of this kind, as long as it facilitates a predefined frictional engagement with the abutting frictional element.

Optionally, the biasing axis A_{V} extends essentially parallel to the torque axis A_{M}. It is conceivable to provide different biasing axes for different frictional elements. Biasing axes and torque axes can extend coaxially, however, it is also conceivable to arrange the individual biasing axes of the individual frictional elements in a manner differing from one another and/or from the torque axis. Optionally, a plurality of frictional elements are arranged adjacent to each other, and in particular symmetrically arranged about the torque axis. Optionally, they are situated on at least one circle about the torque axis. Optionally, they are equally spaced with respect to each other and/or to the torque axis. Optionally, the frictional elements are arranged such that their common center of gravity is on the torque axis.

It should be noted again that frictional element seats can be formed on the first and/or on the second body. In this respect, everything mentioned so far applies to both the one and the other arrangement.

Optionally, at least one frictional element is supported within the frictional element seats without constraint along the biasing axis A_{V}. In particular, it is conceivable in the present context that the frictional elements are supported within the frictional element seats to be rotatable about the biasing axis A_{V}. An advantage of such an embodiment is the extreme ease of assembly of the frictional elements in the frictional element seats. Moreover, the constraint-free support, or the rotatable support, ensures uniform wearing of the frictional elements. Moreover, tolerances between the first and second body, or tolerances within the frictional elements are reliably eliminated. It is conceivable that the frictional elements are able to be arranged within the frictional element seats in such a manner that they do not drop out of the frictional element seats without external influence, for example, an externally applied pressure force (and in particular a force other than gravity). This is optionally the case in particular in a state prior to installation, in which the frictional elements are not yet biased.

Optionally the first body and the second body are formed in such a way that, the frictional elements, due to the bias, are fixed on one body, or supported in the frictional element seats of the one body, clamped by the frictional elements on the other body and, until the overload torque is reached, positionally fixed at least along one axis. The support is optionally configured such that as the overload torque is reached positional compensation between the first body and the second body can be achieved. Due to the bias, the resulting biasing force remains optionally equal. The same is also true for the torque to be transmitted. Optionally, only those load peaks which exceed this torque are eliminated by the frictional elements sliding relative to their frictional counterparts.

Optionally, the frictional element seats are formed such that they form axial guides for the frictional elements. Further optionally, they are formed in such a way that they allow force to be transmitted in a direction deviating from this axis and, in particular, from the biasing axis. In this way, torques applied to the frictional elements via the frictional engagement are transmitted to each body via the frictional element seats. In particular, the torques are transmitted via a transverse force application and/or bending moment application of the frictional elements transverse to the biasing axis.

Optionally, the second body comprises an inner body, and the first body comprises an outer body, or vice-versa, wherein the outer body encloses the inner body at least in part. Optionally, the second body is formed as an inner body and the first body is formed as an outer body, or vice-versa, wherein the outer body encloses the inner body at least in part.

In particular, it is conceivable that the first body comprises a caliper and/or the second body comprises a friction disc, wherein the friction disc optionally includes a plurality of frictional element seats in which the frictional elements are supported to be displaceable along the biasing axis A_{V}. Optionally, it is conceivable in particular in this context that the outer body comprises the frictional counterparts and applies pressure to the frictional elements on the inner body while establishing a frictional engagement. Optionally, the outer body is formed as a caliper and/or the inner body is formed as the friction disc. It is, of course, also possible to provide a plurality of outer bodies and/or inner bodies.

It is conceivable to form the outer body in plural parts and to bias the individual parts, for example partial bodies of the outer body, relative to and against each other while applying pressure to the frictional elements. This biasing force causes the frictional engagement between the frictional elements and the partial bodies of the outer body, or any frictional counterparts formed thereon.

Optionally, the first body includes at least two first partial bodies, in particular first annular elements, and the second body includes at least one second partial body, in particular a second annular element, or vice-versa, which are arranged in part along the biasing axis A_{V} in an alternately stacked configuration. In this way, a bias can be applied, for example, between two first partial bodies and the interposed second partial body comprising the frictional elements. According to the present invention, it is possible not to apply the bias of the first partial body to the second body, but only to the frictional elements supported in the second body. Optionally, it is conceivable to form the second body to be axially displaceable relative to the first body along the biasing axis. It is conceivable to form the first and second partial bodies in such a way that they are arranged in the form of a plurality of disc planes, in particular orthogonal to the biasing axis, optionally extending in parallel to each other, and in particular in a stacked configuration.

Optionally, the driving part or the driven part is connected to one of the at least two first partial bodies, and the other part, i.e., the driven part or the driving part, respectively, is connected to the second partial body. Such a connection can be formed to be torsion-resistant. Such a connection can also be formed to be axially rigid. Such a connection can be a metallurgical bond, for example a welded bolt or a similar connection. In particular, the driving part and/or the driven part has a flange connection on each partial body and in particular a connection connected by means of a releasable flange connection, for example by means of a bolt connection, screw connection or a similar connection. Optionally, the driving part and/or the driven part is releasably connected to each partial body. Optionally, the partial bodies are releasably connected to each other.

Optionally, in relation to the torque axis, a connection region between the driven part or the driving part and the second body is arranged radially inside or outside of a connection region of the first body to the corresponding other part, namely the driving part or the driven part, respectively. Optionally, connection regions formed on the first body and on the second body, and in particular connection regions, are arranged to be radially offset and, in particular, radially offset to each other in relation to the torque axis. Connection regions serve here to connect each body to the driven part or the driving part, respectively. As already mentioned, the connection regions can be flange regions, flange seats, protruding connection elements, connection seats, coupling means or the like to connect and, in particular, releasably connect each body on the driving part or the driven part, respectively.

Optionally, the first body and the second body are formed in such a manner that, in the biased state, at least one partial body of the one body in which the frictional element seats are formed is formed to be moveable and, in particular, displaceable relative to the other body along at least the biasing axis A_{V}. In this way, component tolerances are easily compensated.

Optionally, at least one biasing means is provided, which biases at least two partial bodies of the first body against each other while biasing and, in particular, applying pressure to at least one frictional element on the second body, or vice-versa. Optionally, at least one biasing means is provided which, to establish the frictional engagement between the first body and the second body, biases and, in particular, applying pressure to the frictional elements on the second body along the at, least one biasing axis A_{V} against frictional counterparts on the first body. Optionally, the bias is a spring bias which is applied by at least one biasing means, in particular an elastic screw or bolt connection or the like. In particular, the biasing means can connect at least two parts of a body to each other in a biased state. It is conceivable that the biasing means biases at least two partial bodies of the one body against each other while applying pressure to at least one frictional element situated on the other body. It is conceivable that a frictional engagement force is applied by the at least one optionally elastic biasing means between the at least one frictional element and the respective frictional counterpart.

In a particular embodiment, the two partial bodies of the one body, for example of the first body, enclose at least one partial body of the other body, in particular of the second body, wherein they apply pressure to frictional elements, which are arranged in the frictional element seats of that body. This pressing action results in a frictional engagement between the frictional elements and the partial bodies biased against these frictional elements.

Optionally, at least one frictional element comprises a frictional cylinder or a similar frictional body rotation-symmetrically formed about a rotary axis. It is conceivable to form the frictional element basically as a volume element and, in particular, as an element having at least two end faces, wherein these end faces are in frictional engagement with the frictional counterparts. Optionally, the end faces are parallel to each other and, in particular, formed on two opposite sides of the frictional element. In particular, when the frictional element is formed as a frictional cylinder or a similar frictional body rotation-symmetrically formed about a rotary axis, the end faces optionally form the top and bottom sides of the frictional element. The rotary axis optionally extends parallel to the biasing axis along which the frictional element is moveably supported in the frictional element seat.

In particular, the second body or the first body comprises a plurality of frictional element seats, which penetrate the body along a penetration axis, wherein the frictional elements are supported in the frictional element seats to be moveable and, in particular, displaceable along this penetration axis. Optionally the frictional element seats are formed as drilled holes, which essentially entirely penetrate the body comprising the frictional element seats. The frictional elements are optionally arranged such that they penetrate the body from one side to the other side and protrude from this body on both sides and can thus be brought into contact with the other body. It is possible, for example, for form the one body and, in particular, the second body, as a disc element and, in particular, a friction disc, in which a plurality of frictional element seats are formed in the form of drilled holes or the like, in which the frictional elements are inserted in such a manner that they protrude from both sides of the disc.

Optionally, the frictional elements can be inserted and, in particular, can be exchanged, without the use of a tool, in each of the frictional element seats, when the second body is not installed on the first body. Fixing the frictional elements in the frictional element seats is optionally provided as soon as the second body is installed on the first body. In particular, it is conceivable that the frictional elements are retained in the frictional element, seats on the second body by the first body, or vice-versa.

Further embodiments of the invention can be derived from the dependent claims.

The invention will be described in the following with reference to exemplary embodiments, which will be explained in more detail by the accompanying drawings, in which:

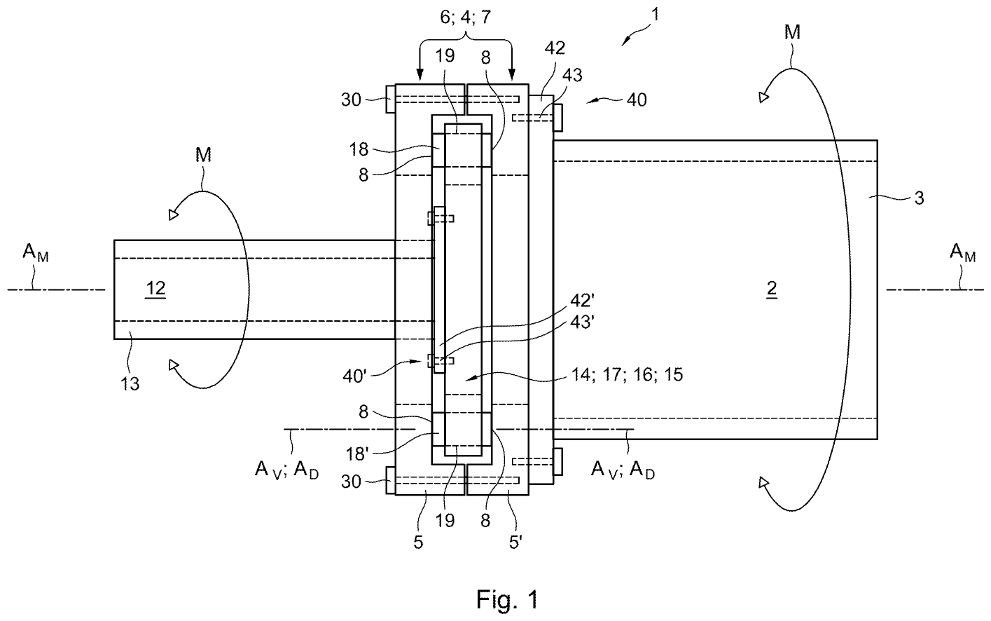

FIG. 1 shows a schematic side view of an embodiment of the overload clutch according to the invention;

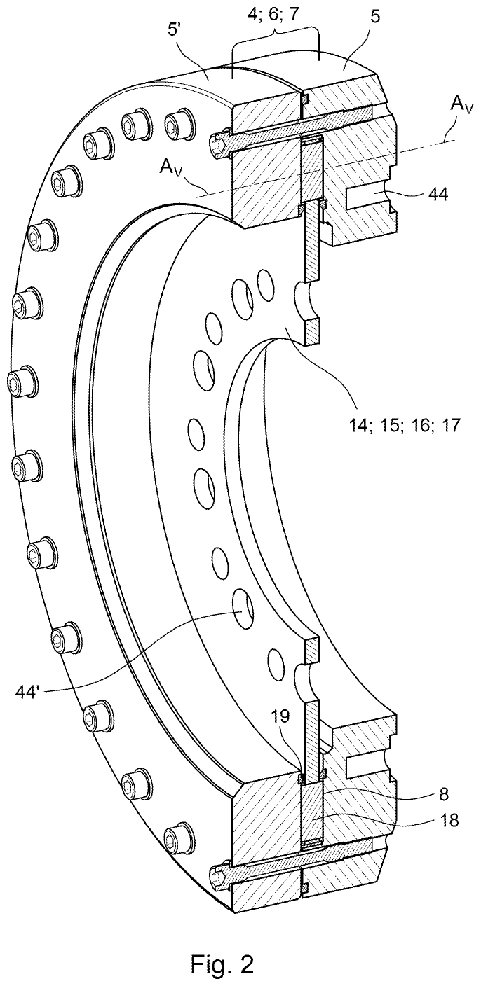

FIG. 2 shows an isometric partial view of a further embodiment of the overload clutch according to the invention;

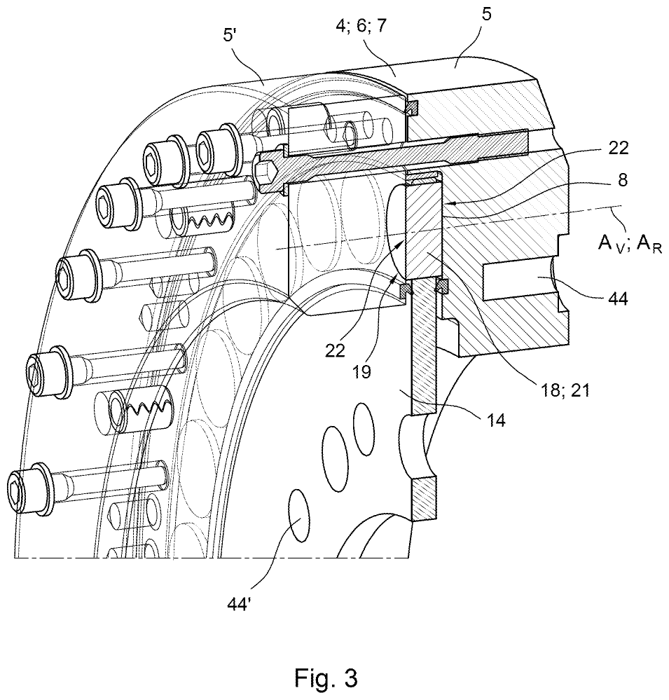

FIG. 3 shows an isometric detail view of the embodiment of FIG. 2;

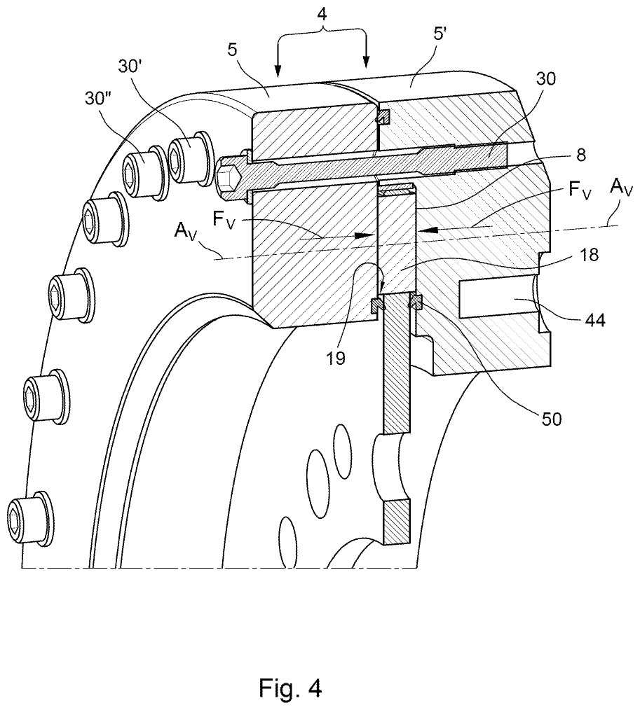

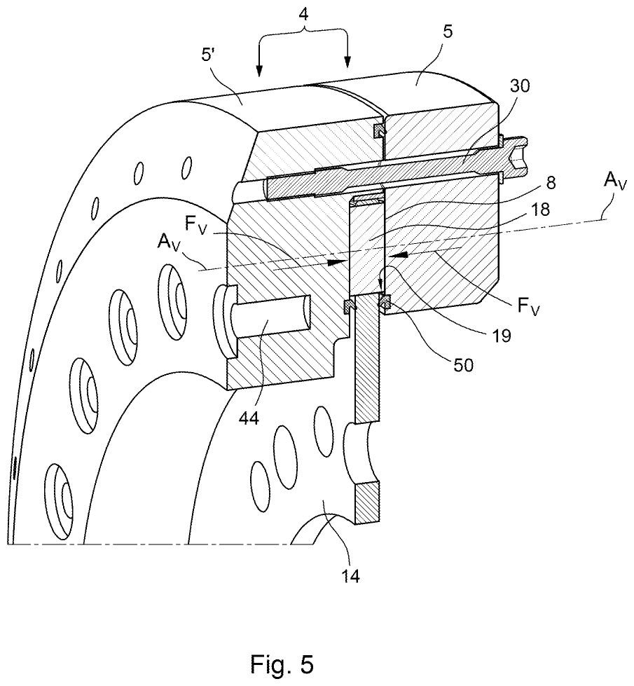

FIGS. 4 and 5 show further schematic detail views of the embodiment of FIG. 2;

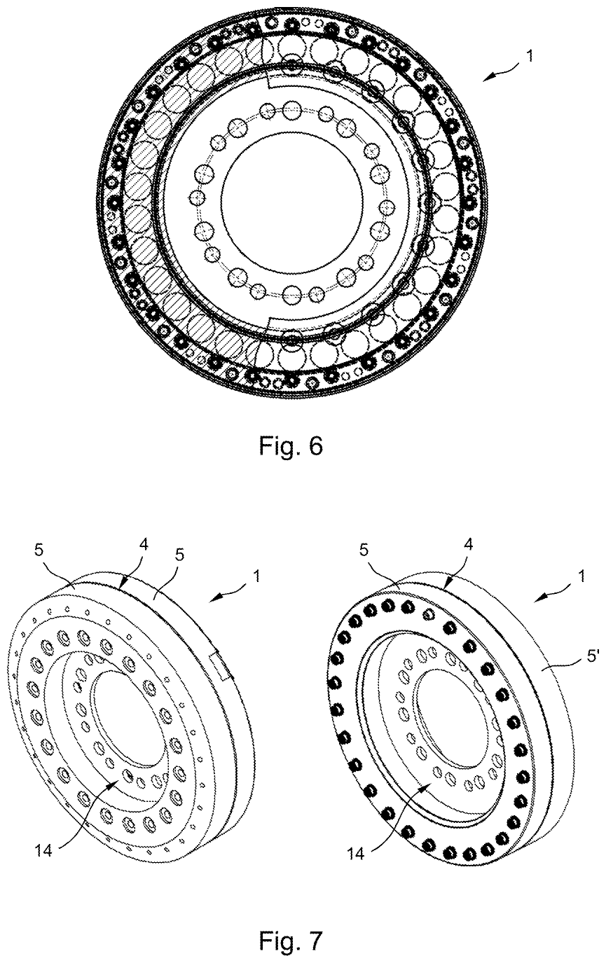

FIG. 6 shows a front view of a further embodiment of the overload clutch according to the invention;

FIG. 7 shows two isometric views of the embodiment of FIG. 6;

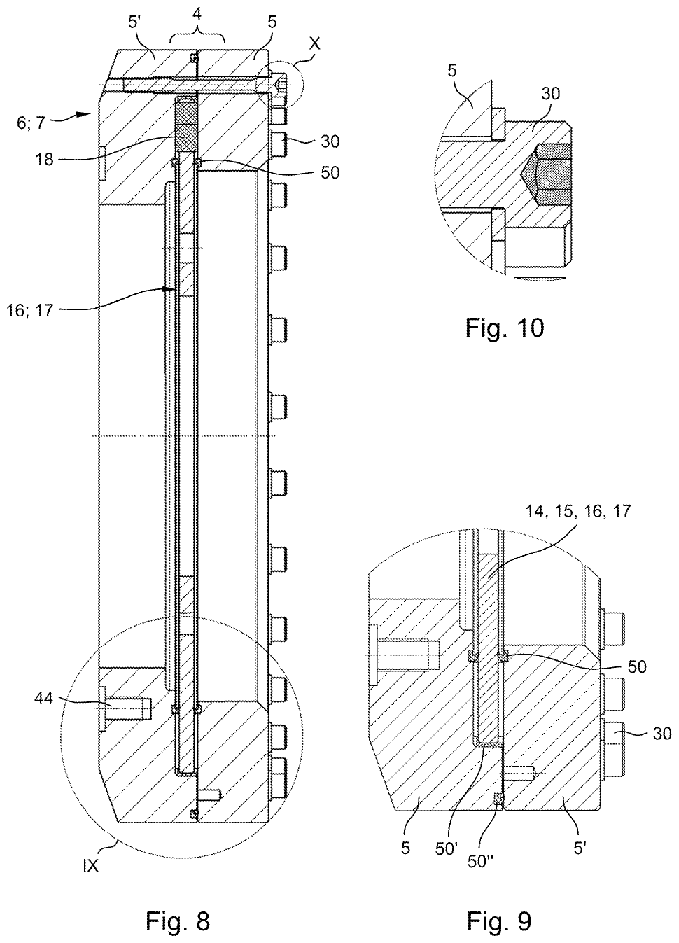

FIG. 8 shows a cross-sectional view of the embodiment of FIG. 6; and

FIGS. 9 and 10 show detail views of the embodiment of FIG. 6 as indicated in FIG. 8.

The same and equivalent components will be designated with the same reference numerals in the following, wherein high indices will sometimes be used for the purpose of differentiation.

FIGS. 1 and 2-5 show two embodiments of the overload clutch according to the invention. In each case, the overload clutch 1 is configured as a slip clutch and is adapted to transmit a torque M acting about a torque axis A_{M} from a driving part 2, for example a transmission of a drive shaft 3 of a wind turbine, in particular, to a driven part 12 situated, in particular, axially downstream, for example a drive train 13 of a generator. To avoid, for example, a torque being fed back from the side of the generator to the drive shaft 3, the slip clutch, or overload clutch, 1 only transmits a torque that is limited in its strength. The overload clutch comprises a first body 4 and a second body 14 connected to each other by frictional engagement and allows a torque to be transmitted between the driving part 2 and the driven part 12.

It should be noted that in the scope of the present disclosure everything that is said about the first body 2 can alternatively or identically also apply to the second body 12, or vice-versa.

In the embodiment shown here, the first body 4 is connected to the driving part 2, while the second body 14 is connected to the driven part 12. The connection is implemented, for example by means of a flange connection or any other type of connection 40, in particular of the releasable kind, as shown in FIG. 1. Such a connection 40 can be, in particular, as shown, a flange connection comprising a flange 42 connected to the driving part 2 or the driven part 12. In the present embodiment, both parts 2, 12 comprise respective flange connections, however, any other type of connection can, of course, also be provided between driving and driven parts and the first and second parts 4, 14 of the overload clutch, respectively. In the present embodiment 4, each flange has an interlocking connection to the driven part 12, or the driving part 2 and can be releasably connected to each of the first body 4, or the second body 14, of the overload clutch by means of bolt connections 43. As shown, in particular, in the embodiments of FIGS. 2-5, corresponding bolt seats 44 or bolt through holes 44 are provided on each of bodies 4 and 14, respectively, to receive the bolts 43 (see FIG. 1). In the present case, the connections between the driving part, or the driven part and each of bodies 4, 14 are configured to be torque-resistant so that the torque from the driving part is transmitted to the driven part via the overload clutch.

In this embodiment, the second body 14 comprises a plurality of frictional elements 18 supported on the second body 14 in frictional element seats 19 and transmit the torque M, while establishing a frictional engagement between the first body 4 and the second body 14. The frictional elements 18, supported on the second body 14, are thus in frictional engagement with frictional counterparts 8 situated on the first body 4. The frictional elements, while establishing a frictional engagement between the first body 4 and the second body 14, are biased against frictional counterparts 8 on the first body 4 along a biasing axis A_{V}, and in the present embodiment, clamped against the frictional counterparts 8 with the application of a pressure. The frictional elements 18 are supported in the frictional element seats 19 within the second body 14 to be moveable and, in particular, displaceable along each biasing axis A_{V}.

It can also be seen that, in the present embodiment, the second body 14 optionally comprises an inner body 17 and the first body 4 optionally comprises an outer body 7. The reverse is, of course, also possible. In the present embodiment, the outer body 7 at least partially encloses the inner body 17. In particular, the first body 4 optionally comprises a caliper 6 and/or the second body 14 optionally comprises a friction disc 16. The second body and, in particular, the friction disc 16 can comprise a plurality of frictional element seats 19 in which the frictional elements 18 are supported to be moveable, optionally displaceable, in particular, along the biasing axis A_{V}.

It can be seen that, in the present embodiment, the frictional elements 18 are optionally clamped between first partial bodies 5 of the first body 4, or outer body 7. They penetrate the second body 14 and, in particular the friction disc 16, thus enabling a torque transmission between the first body 4 and the second body 14.

Optionally, the first body 4 comprises at least two first partial bodies 5, in particular first annular elements, and the second body 14 comprises at least one second partial body 15, in particular a second annular element, or vice-versa, which are alternately stacked along the biasing axis A_{V} and, in particular arranged in parallel to each other in a plurality of disc planes orthogonal to the biasing axis.

To enable essentially backlash-free torque transmission, the support of the frictional elements 18 in the frictional element seats 19 of the friction disc 16, or the second partial body 15, is formed in a backlash-free manner in an axis orthogonal to the biasing axis A_{V}. Optionally, the frictional elements are supported in the frictional element seats in such a manner that any movement along an axis deviating from the biasing axis is essentially prevented. The frictional elements are optionally fitted in the frictional element seats so that they are able to move only along the biasing axis A_{V}, but are axially fixed in the other directions. It is conceivable to support the frictional elements in the frictional element seats 19 in a manner in which they are backlash-free and/or constraint-free other than along the biasing axis A_{V}. It is also conceivable to support the frictional elements 18 in the frictional element seats 19 to be rotatable about the biasing axis A_{V}.

As shown, in particular, in FIG. 3, at least one frictional element 18 comprises or is formed as a frictional cylinder 21 or a similar frictional body rotation-symmetrically formed about a rotary axis. The rotary axis can optionally be parallel to the biasing axis A_{V}, along which the frictional element is moveably supported in the frictional element seats 19. In the present embodiment, the frictional elements 18 are formed as frictional cylinders, each comprising two opposite coplanar end faces 22. Each of these end faces 22 of the frictional elements 18 are in frictional engagement with frictional counterparts 8 on the first body 4. As already mentioned, these frictional counterparts 8 can be coatings, inlays, additional components arranged on the body 4, but also untreated or treated partial areas of the first body 4.

As can also be seen in FIG. 3, the frictional elements 18 are optionally insertable and, in particular, exchangeable in each of the frictional element seats 19 without the use of a tool, when the second body is not installed on the first body. It can also be seen that, in the installed state and in the cooperation of the first and second bodies, the frictional elements are optionally held in the frictional element seats 19 by the first body 4.

In the embodiment shown in FIG. 3, the second body 14 optionally comprises a plurality of frictional element seats 19 penetrating the second body 14 along a penetration axis A_{D} (see FIG. 1). The frictional elements 18 are supported in the frictional element seats 19 to be moveable along this penetration axis. The penetration axis A_{D} can extend in parallel to, or can be coaxial with, the biasing axis A_{V} and/or the rotary axis A_{R} and/or to the torque axis A_{M}. Optionally, the frictional element seats 19 are formed as drilled holes and are formed, in particular, orthogonal in a disc or in a similar element, which the second body comprises.

It becomes clear, in particular, in FIGS. 4 and 5, that the first body 4 and the second body 14 are optionally formed in such a manner that the frictional elements inserted in the frictional element seats 19 are clamped by the frictional counterparts 8. The result is a frictional engagement between the first body 4 and the second body 14 to transmit the torque M shown in FIG. 1. As shown in FIGS. 1-5, the first body 4 optionally comprises at least two first partial bodies 5, in particular first annular elements, and the second body 14 comprises at least one second partial body 15, in particular a second annular element, or vice-versa. These partial bodies 5, 15 are optionally arranged in an alternately stacked configuration, in particular, along the biasing axis A_{V} and/or the torque axis A_{M} and/or the rotary axis A_{R}. For example, a first partial body 5 of the first body 4 is followed by a second partial body 15 of the second body 5, followed by a further first partial body 5 of the first body 4 in the axial direction (of at least one of the above-mentioned axes).

FIGS. 4 and 5 further show an embodiment in which the bias is a spring bias, applied by at least one biasing means 30, here, in particular, an elastic bolt or a similar attachment means. This elastic bolt is formed in such a way that it is elastically longitudinally extended by the biasing force F_{V} applied to the frictional elements, and thus applies the biasing force along the biasing axis A_{V} to the first body 4 or its partial bodies 5 and the frictional elements 18.

In the present embodiment, the biasing means 30 is optionally arranged in such a manner that at least two partial bodies 5 of the one body 4 is biased against the other body, here the second body 14, while applying pressure to at least one frictional element 18.

In the present embodiment, at least one sealing element 50 is optionally arranged between the first body 4 and the second body 14, which extends between the first body 4 and the second body 14 (see FIGS. 4 and 5). This sealing element is optionally in sliding engagement with at least one of bodies 4, 14. It is optionally formed such that the ingress of objects from the outside of the overload clutch 1 into the frictional engagement area between the frictional counterparts 8 and the frictional elements 18 is prevented. The sealing element 50 can be optionally configured in such a manner that it causes a biasing force between the first body 4 and the second body 14 and thus elastically defines the position of the second body 14 relative to the first body 4.

It is possible, in particular, in the present context, that the first body 4 and the second body 14 are formed in such a manner that, in the biased state, as shown, for example, in FIG. 4, at least one partial body 15 of the one body 14, in which the frictional element seats 19 are formed, is formed to be moveable and, in particular, displaceable relative to the other body 4 along the biasing axis A_{V} and/or the rotary axis A_{R} and/or the torque axis A_{M}. Due to the sealing element 50 which, in the present case, is formed to be elastic, this ability to be longitudinally displaced is ensured.

As shown, in particular, in FIG. 1, in the present embodiment, the driving part 2 is optionally connected to the first body 4, and the first body 4 and the driven part 12 are optionally connected to the second body 14. In relation to the torque axis, the connection region between the driven part 12 or the driving part 2 and the second body can be arranged to be radially inward from a connecting region of the first body to the corresponding driving part 2 and driven part 12, respectively. In the present embodiment, the connection region between the driven part 12 and the second body 14 is situated within the connecting region of the driving part 2 to the outer body 4. Both connecting regions are optionally coaxially arranged with respect to each other. This optionally also applies to the rotary axis A_{M} which coaxially extends in both parts, in particular in the driving part 2 and the driven part 12. Optionally, the first body and the second body are configured in such a manner that due to the bias the frictional elements 18 on one body 14 are clamped by the frictional counterparts 8 on the other body 4, here the first body 4, and are optionally positionally fixed along at least one axis until the overload torque is reached.

FIGS. 6 to 9 show a further embodiment of the overload clutch according to the invention corresponding, in its basic components, to the embodiments of overload clutches described before. Unless otherwise indicated, everything that was described above also applies to the embodiment shown here. As before, a first body 4 is shown, also configured to be in two parts, comprising two first partial bodies 5, and a second body 14, again configured as a friction disc and comprising frictional elements 18 supported in frictional element seats 19 of the second body 14.

Again, the two first partial bodies 5 of the first body 4 are biased towards each other via elastic biasing means 30 or elastic bolts while clamping the frictional elements 18. Again, it is conceivable to form the first body 4 as a caliper 6 or an outer body 7. This is identically applicable to the second body 14, which can be optionally formed as a friction disc 16, or as an inner body 17.

### LIST OF REFERENCE NUMERALS

1 overload clutch
2 driving part
3 drive shaft
4 first body
5 first partial body
6 caliper
7 outer body
8 frictional counterpart
12 driven part
13 drive train
14 second body
15 second partial body
16 friction disc
17 inner body
18 frictional element
19 frictional element seat
22 end face
30 biasing means
40 connection
42 flange
43 bolt
44 bolt seat
A_{M} torque axis
A_{V} biasing axis
A_{R} rotary axis
F_{V} biasing force

1. An overload clutch for the transmission of a torque limited in its strength, acting about a torque axis, from a driving part, to an axially downstream driven part, comprising: at least one first body connected to either the driving part or the driven part in a torque-resistant manner, and at least one second body correspondingly connected to the other of the driving part and the driven part in a torque-resistant manner, respectively, wherein the at least one second body comprises a plurality of frictional elements biased against frictional counterparts on the at least one first body along at least one biasing axis while forming a frictional engagement between the at least one first body and the at least one second body, wherein the plurality of frictional elements are supported in frictional element seats within the at least one second body to be moveable along the at least one biasing axis, clamped by the frictional counterparts due to a biasing force, and fixed in position at least until an overload torque is reached;
characterized in that
the at least one second body includes a plurality of frictional element seats penetrating the at least one second body along a penetration axis, wherein the plurality of frictional elements (18) are supported in the plurality of frictional element seats to be moveable along said penetration axis.

2. The overload clutch according to claim 1,
characterized in that
the biasing axis extends essentially parallel to the torque axis.

3. The overload clutch according to claim 1,
characterized in that
the plurality of frictional elements are supported in the plurality of frictional element seats to be rotatable about the biasing axis.

4. The overload clutch according to claim 1,
characterized in that
the at least one second body comprises an inner body and the at least one first body comprises an outer body, or vice-versa, wherein the outer body encloses the inner body at least in part.

5. The overload clutch according to claim 1,
characterized in that
the at least one first body comprises a caliper, and/or the at least one second body comprises a friction disc, wherein the friction disc comprises the plurality of frictional element seats, in which the plurality of frictional elements are supported to be displaceable along the biasing axis.

6. The overload clutch according to claim 1,
characterized in that
the at least one first body includes two first partial bodies, and the at least one second body includes at least one second partial body, or vice-versa. cm 7. The overload clutch according to claim 6,
characterized in that
the first and second partial bodies are alternately stacked in particular along the biasing axis and arranged parallel to each other in a plurality of disc planes extending orthogonal to the biasing axis.

8. The overload clutch according to claim 1,
characterized in that
the at least one first body and the at least one second body are formed such that, in a biased state, at least one partial body of one of the at least one first body and the at least one second body in which the plurality of frictional element seats are formed, is formed to be moveable relative to at least one partial body of the other of the at least one first body and the at least one second body is formed to be displaceable at least along the biasing axis.

9. The overload clutch according to claim 1,
characterized in that
at least one biasing means is provided, which biases at least two partial bodies of the at least one first body against each other while biasing and applying pressure to at least one frictional element situated on the at least one second body, or vice-versa.

10. The overload clutch according to claim 1,
characterized in that
at least one biasing means is provided which, for establishing the frictional engagement between the at least one first body and the at least one second body, biases and applies pressure to the plurality of frictional elements situated on the at least one second body along the at least one biasing axis against frictional counterparts situated on the at least one first body.

11. The overload clutch according to claim 1,
characterized in that
at least one frictional element comprises a frictional cylinder symmetrically formed about a rotary axis.

12. The overload clutch according to claim 1,
characterized in that
the plurality of frictional element seats are formed as drilled holes.
